(19) United States
(12) Patent Application Publication
(10) Pub. No.: US 2007/0268955 A1
(43) Pub. Date: Nov. 22, 2007

(54) Thermal fluid device with remote temperature indicator

(76) Inventors: Hermann K. Pohl, Buffalo, NY (US); William J. Kelner, Tonawanda, NY (US); William Rustay, West Amherst, NY (US)

Correspondence Address: Kevin D. McCarthy;Roach Brown McCarthy & Gruber, P.C., 1620 Liberty Building, 420 Main Street, Buffalo, NY, 14202, US

(21) Appl. No.: 11/436,140

(22) Filed: May 17, 2006

(51) Int. Cl. G01J 5/00

(52) U.S. Cl. 374/121

(57) ABSTRACT

The present invention is directed to a fluid medium delivery system that measures a patient's temperature, and at least transmits that measurement to an infrared emitter. That emitter transmits an infrared signal corresponding to the measurement of the patient's temperature to a receiver. The receiver converts that infrared signal into a digital and/or analog signal that is transmitted to a device that records, and/or illustrates the measurement so medical practitioners can monitor the temperature without having to look at and/or for the fluid medium delivery system.

### FIELD OF THE INVENTION

The present invention relates to an automatic patient control device that delivers a medium toward a patient.

### BACKGROUND OF THE INVENTION

Gaymar Industries, Inc. (the assignee of the present invention) is the owner and manufacturer of the MEDI-THERM II® hypo/hyperthermia machine—a fluid medium delivery device. This machine delivers water and/or other fluids to a blanket (i.e., Gaymar's Hypo/hyperthermia blanket, Gaymar's THERMACARE® blanket [has apertures to allow a fluid to be applied to the patient] or Gaymar's MEDI-TEMP® blanket), a mattress pad (i.e., Gaymar's Alternating Pressure Pad), a chair pad, or a mattress unit (i.e., Gaymar's CLINIDYNE® mattress) (collectively the blankets, pads, and mattresses and obvious variations thereof are hereinafter “Objects”). In particular, the Objects surround a patient or applied to predetermined portions of the patient.

The fluid medium delivery device is used extensively in operating rooms or other hospital-like rooms to (a) control the patient's temperature, (b) stabilize a patient who is experiencing hypothermia or hyperthermia or, (c) in some instances, actively cause hypothermia or hyperthermia as therapy.

A problem with the prior fluid medium delivery devices is that the display/input unit is on the exterior of the fluid medium delivery device. It has been determined that the display/input unit is too small, inconvenient to view, difficult to view, and difficult to monitor within an operating room setting. The present invention solves this problem.

### BRIEF DESCRIPTION OF THE DRAWINGS

FIG. 1 illustrates the exterior embodiment of the present invention.

FIG. 2 illustrates a schematic flow diagram of how the present invention distributes a liquid medium to and from an Object

FIGS. 3A, 3B, and 3C illustrate graphs showing the actual temperature of a patient and the temperature of the desired medium applied to the patient over time of the present invention.

FIG. 4 illustrates an alternative embodiment of FIG. 1.

FIG. 5 illustrates an Object, wherein the Object is a blanket having a plurality of channels and a plurality of apertures for directing the desired medium in the direction of the user.

FIG. 6 illustrates an Object, wherein the Object is a mattress.

FIG. 7 illustrates an Object, wherein the Object is a mattress pad.

### SUMMARY OF THE PRESENT INVENTION

The present invention is directed to a fluid medium delivery system that measures a patient's temperature, and at least transmits that measurement to an infrared emitter. That emitter transmits an infrared signal corresponding to the measurement of the patient's temperature to a receiver. The receiver converts that infrared signal into a digital and/or analog signal that is transmitted to a device that records, and/or illustrates the measurement so medical practitioners can monitor the temperature without having to look at and/or for the fluid medium delivery system.

### DETAILED DESCRIPTION OF THE PRESENT INVENTION

The MEDI-THERM II® device is one version of a fluid medium delivery device 10. The exterior of the device 10 has at least one supply outlet 14, a kill switch 444 which can shut down the entire device 10 by conventional interconnections between the various components of device 10, a display/input unit 45, at least one outlet conduit 18, a return conduit 50, a return inlet 52, an infrared emitting circuit 800, an infrared receiver circuit and signal converter 802, a signal conduit 804, an operating monitor 806, and an Object 16.

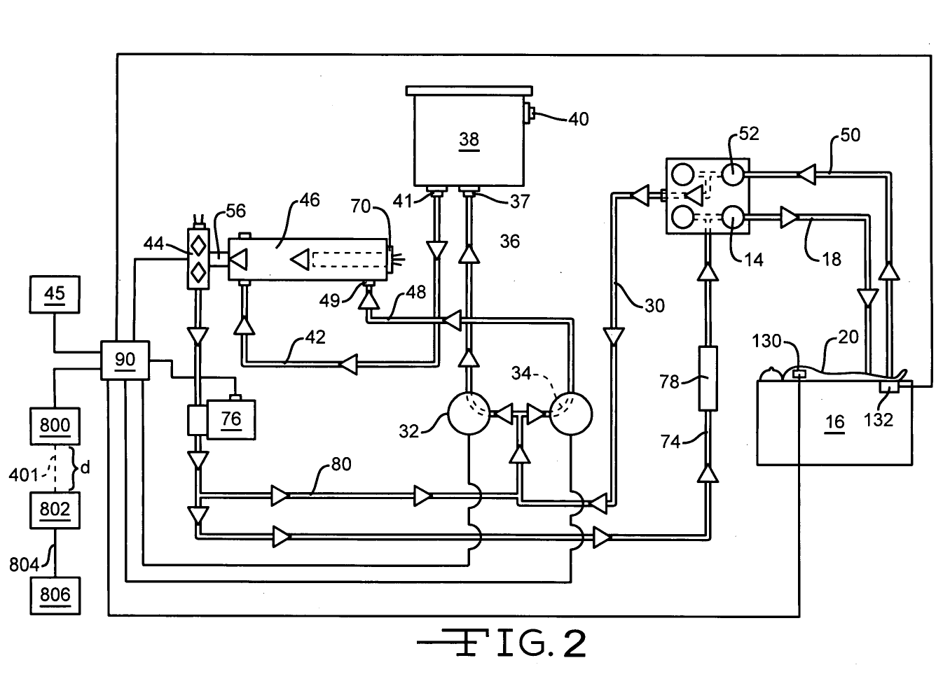

FIG. 2 is a flow diagram of how device 10 distributes the liquid medium. The liquid medium enters device 10 through the return inlet 52. From return inlet 52, the liquid medium traverses through the first conduit 30 to the first solenoid valve 32 for a cold liquid medium or the second solenoid valve 34 for a warm liquid medium.

From the first solenoid 32 which is controlled by a processor unit 90 (to be described later), the liquid medium goes through a second conduit 36 and the first cold inlet 37 of the cold reservoir 38 to the cold reservoir 38. The cold reservoir 38 is a conventional cooling unit that cools a liquid, i.e., a refrigeration system's evaporation or an air conditioner's evaporator. The evaporator in the reservoir maintains a large quantity of fluid at a predetermined temperature normally 4° C. (hereinafter “Cold Medium”). Liquid medium entering the reservoir is cooled by mixing with the liquid medium already within the reservoir. If the cold reservoir 38 overflows, the liquid medium escapes from the device 10 through the overflow outlet 40. The Cold Medium then flows through the cold outlet 41 of the cold reservoir 38 and the third conduit 42 to a manifold 44.

Similarly from the second solenoid 34 which is controlled by the processor unit 90, the liquid medium goes to a hot reservoir 46 through the fourth conduit 48 and the hot inlet port 49 of the hot reservoir 46. The hot reservoir 46 is a conventional heating apparatus that heats the liquid medium (hereinafter “Warm Medium”). The warm Medium flows through the warm outlet 56 of the hot reservoir 46 to the manifold 44.

At the manifold 44, the Warm Medium and the Cold Medium converge. The selection of which liquid medium path is active and its length of time active is controlled via solenoid valves 32 and 34 to attain a desired temperature. The Mixed Medium is drawn through the sixth conduit 74 by the conventional pump 76, to supply outlet 14. A flow switch 78 on the sixth conduit 74 senses whether the Mixed Medium reaches the supply outlet 14. Obviously, when the flow switch 78 is on, the Mixed Medium reaches the supply outlet 14. And when the flow switch 78 is off, the Mixed Medium fails to reach the supply outlet 14. A seventh conduit 80 connects with the first conduit 30, to provide quelling of temperature overshoot when no Object is connected.

When the Mixed Medium reaches the supply outlet 14, the liquid medium is released into the outlet conduit 18 into the Object 16. The Mixed Medium traverses through the Object 16 to the return conduit 50 and into the return inlet 52. And the process is repeated.

The Mixed Medium temperature is altered by the first solenoid valve 32 which controls the intake of the Warm Medium and the second solenoid valve 34 which controls the intake of the Cold Medium. The amount of medium each solenoid valve 32, 34 allows into the manifold 44 depends on the temperature of the mammal 20 and, sometimes depending on the embodiment of the present invention, the temperature of the Mixed Medium in the Object.

The temperature of the mammal 20 is measured by the first conventional temperature sensing device 130 (“First Measurement”) connected to a preselected portion of the mammal 20. The First Measurement is transmitted to the processing unit 90 and the infrared emitting circuit 800.

The temperature of the Mixed medium in the Object is measured by the second conventional temperature measuring device 132 (“Second Measurement”) placed in the Object, in the supply conduit 18, the supply outlet,14, the manifold 44, or the sixth conduit 74. The Second Measurement is transmitted to the processing unit 90 and, in some embodiments, the infrared emitting circuit 800.

Initially, the processing unit 90 compares the First Measurement to a predetermined, programmed, and desired set point body temperature of the mammal 20 (hereinafter “Set Point Body Temperature”). The processing unit 90 determines the differential and, in return, adjusts the temperature of the Mixed Medium to a preset differential by controlling the amount of the Warm Medium and Cold Medium that passes by the respective solenoid valves 32, 34.

The processing unit 90 also transmits the First Measurement and sometimes the Second Measurement to the display/input unit 45 on the exterior surface of the device 10. The display/input unit 45 displays the First Measurement and depending on the embodiment, the Second Measurement.

When the First Measurement is above the Set Point Body Temperature, the processing unit 90 controls the first and second solenoid valves 32, 34 to alter the temperature of the Mixed Medium to a predetermined differential from the First Measurement. The predetermined differential ranges from 0.1 to 35° Celsius, and preferably ranges from 5 to 15° Celsius, below the First Measurement.

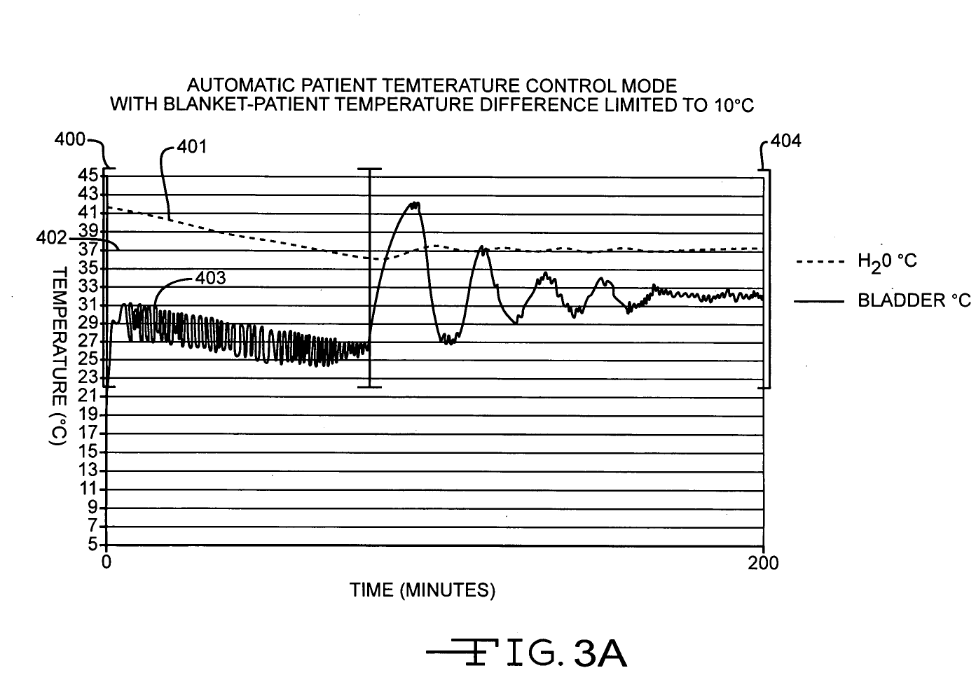

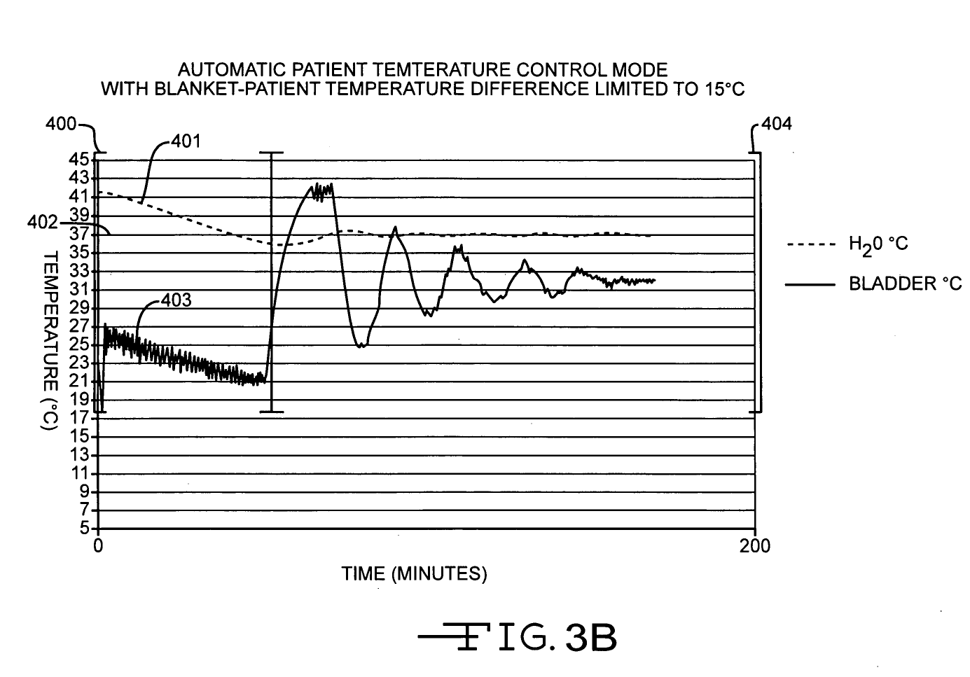

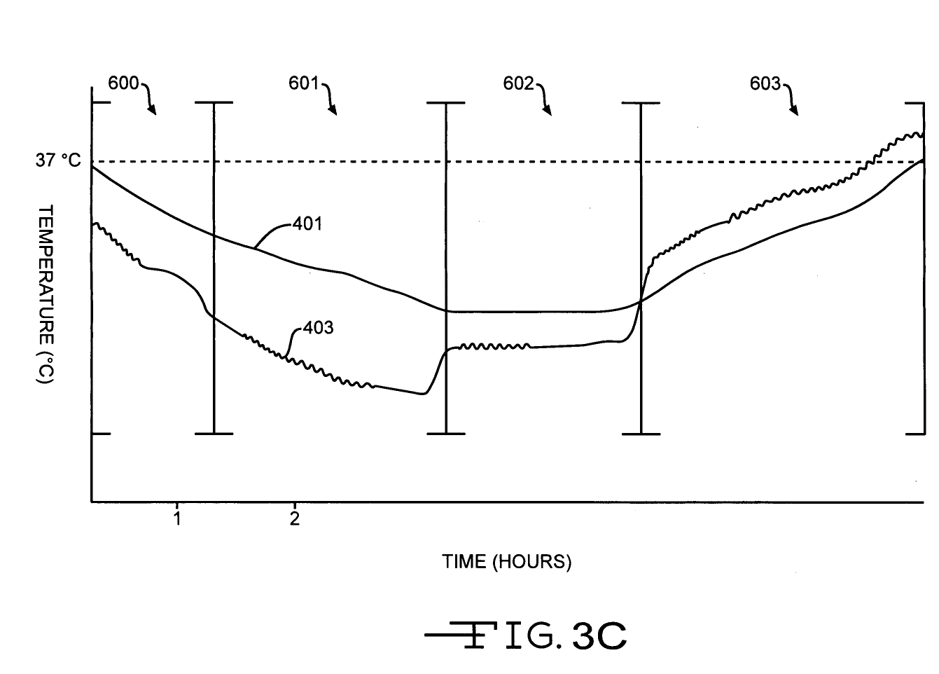

Initially when the First Measurement is above the Set Point Body Temperature, the device 10 applies, by the processing unit 90 controlling the first and second solenoids 32, 34, a Mixed Medium into the Object 16 having a predetermined differential from the First Measurement. The predetermined differential ranges from 0.1 to 35° Celsius, and preferably ranges from 5 to 15° Celsius, below the First Measurement. FIGS. 3a (a 10° C. differential) and 3b (a 15° C. differential) illustrate this design feature in section 400 wherein the temperature of the First Measurement is represented as line 401, the Set Point Body Measurement is represented as line 402, and the Mixed Medium is represented as line 403 at different differentials. Once the First Measurement 401 falls below the Set Point Body Temperature 402, the first and second solenoid valves 32, 34 alter the temperature of the Mixed Medium, to eventually stabilize the patient to the Set Point Body Temperature. See section 404 of FIGS. 3A and B.

Likewise, when the First Measurement is initially below the Set Point Body Temperature, the processing unit 90 controls the first and second solenoid valves 32, 34 to alter the temperature of the Mixed Medium to a pre-set differential from the First Measurement. The pre-set differential ranges from 0.1 to 35° Celsius, and preferably ranges from 5 to 15° Celsius, above the actual temperature, so long as the processing unit 90 does not alter the temperature of the Mixed Medium above a predetermined-maximum temperature. The predetermined-maximum temperature is 0.1 to 10° Celsius, and preferably about 5° Celsius, above the normal temperature of the mammal.

And when the First Measurement is about the Set Point Body Temperature, the processing unit 90 controls the first and second valves 32, 34 to alter the temperature of the Mixed Medium to a temperature which will maintain the First Measurement about the Set Point Body temperature.

The liquid medium can be any liquid that transfers thermal energy to a mammal 20 and wherein the liquid can be readily altered to a Warm Medium or a Cold Medium, like water or water-based solutions.

Alternatively, the liquid medium set forth in the present invention can be substituted by a gaseous medium, like air. When device 10 delivers air instead of a liquid medium, device 10 is altered. Instead of having valves 32, 34, conduits 48, 36, 42, and reservoirs 38, 46, the device 10 has a different temperature and intake system.

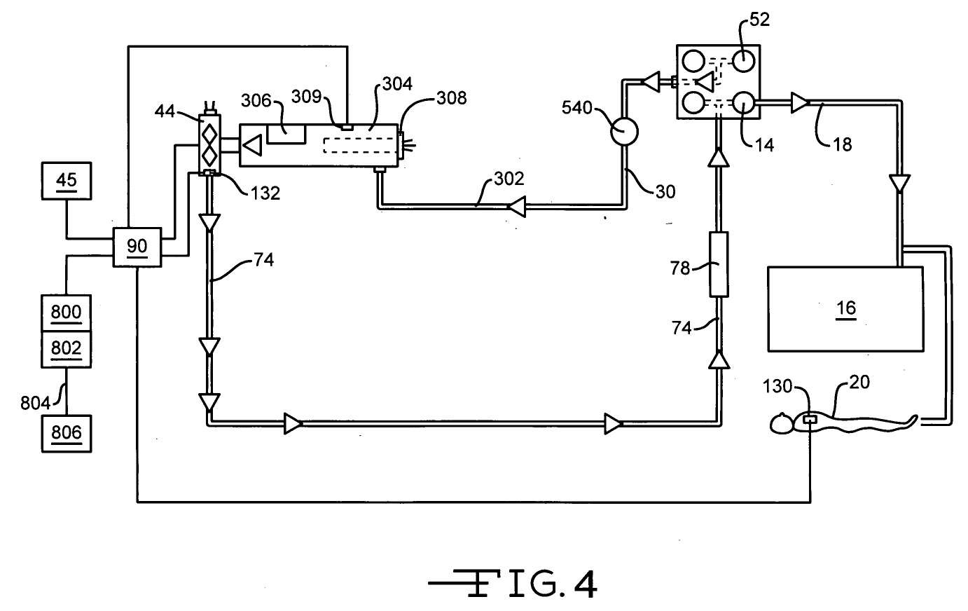

Turning to FIG. 4, the air is drawn into device 10 through the inlet 52 by a conventional fan 540. From the inlet 52, the air medium traverses through a ninth conduit 302 to a plenum 304. The plenum 304 has a cooling unit 306, like an air conditioner, and a heating unit 308, like a heat pump. The processing unit 90 controls the cooling unit 306 and the heating unit 308 by conventional methods well known to those skilled in the art.

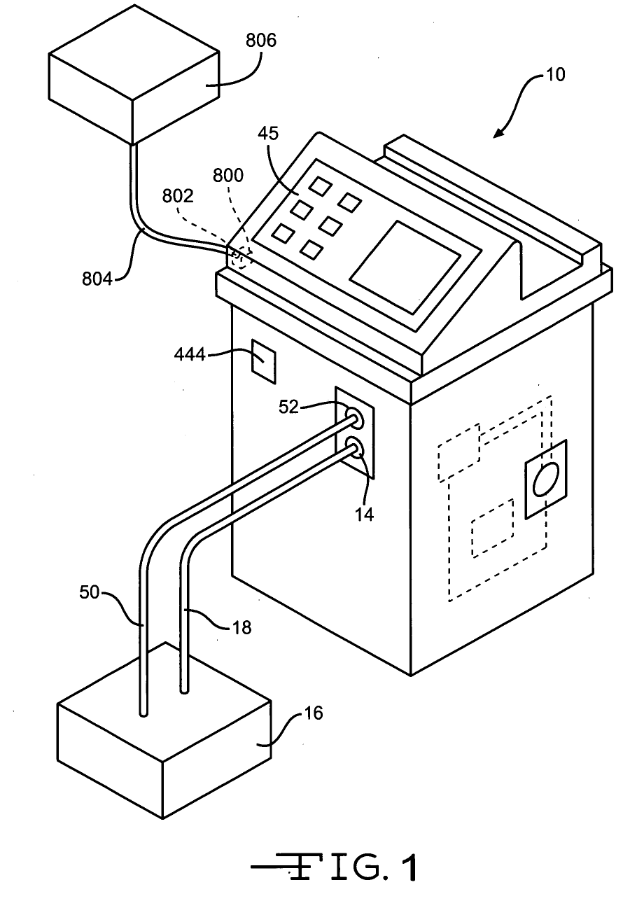

The air then escapes into the manifold 44 and follows route set forth for FIG. 1, except the air does not return to the device 10 from the Object 16. The temperature of the Mixed Medium in the Object 16 is measured by the second conventional temperature measuring device 132 placed in the Object 16, in the supply conduit 18, the supply outlet 14, the sixth conduit 74, the manifold 44 or the plenum 304. The measurement from the second temperature measuring device is transmitted to the processing unit 90.

The processing unit 90, in return, alters the operation of the cooling unit 306 and the heating unit 308 to obtain the desired air temperature.

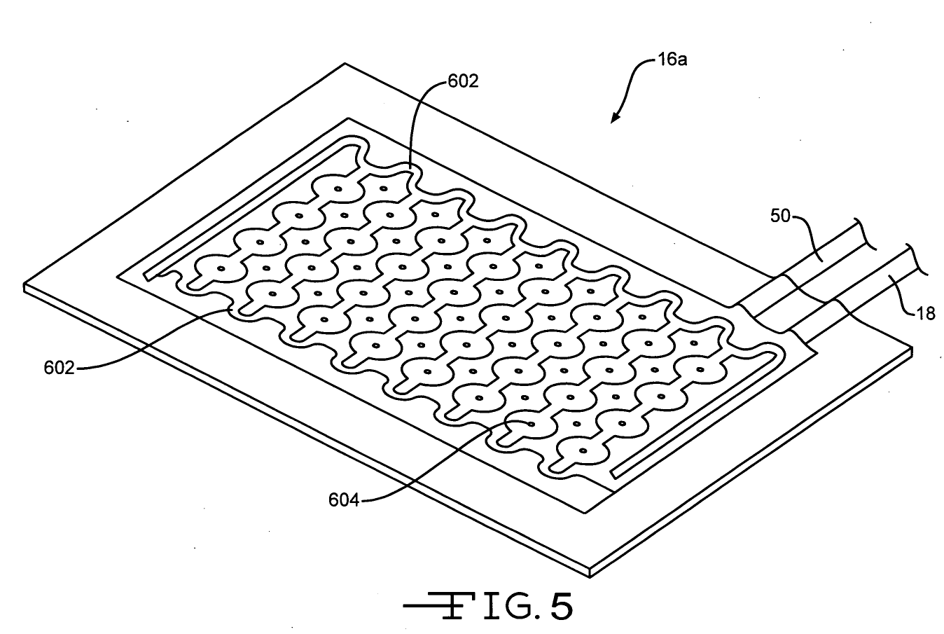

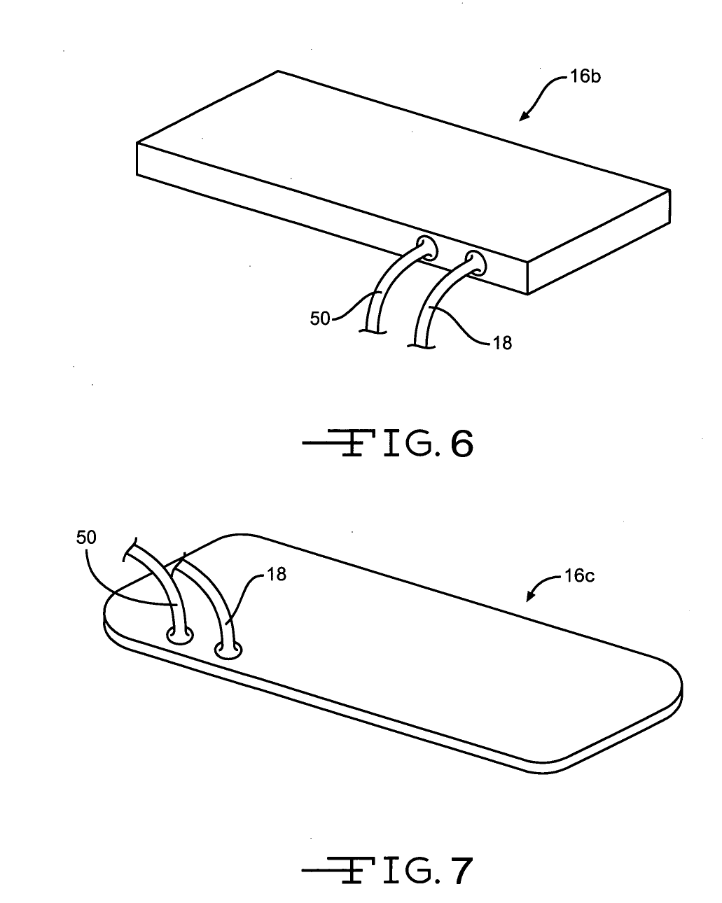

The Object 16 can be any suitable object, such as a blanket, a mattress, or a mattress pad. Such Objects 16 are shown in FIGS. 5-7. In particular, FIG. 5 shows a blanket 16a having a plurality of channels 602 and a plurality of apertures 604 for directing the desired medium in the direction of the user. Although FIG. 5 shows outlet conduit 18 directing the desired medium into the blanket 600, the outlet conduit 18 may be positioned to direct the desired medium under the blanket 600. Referring to FIG. 6, the Object 16 may be a mattress 16b. Alternatively, the Object 16 may be a mattress pad 16c, as shown in FIG. 7.

Alternatively, the processing unit 90 can be programmed and/or pre-set to alter the temperature of the Mixed Medium and/or the temperature of the mammal 20 at a set rate. For example, altering the temperature of the Mixed Medium or mammal 16 at 2° C., or any other temperature change, per hour. These changes can occur in time increments, as well. For example, the processing unit 90 can be programmed, as illustrated in FIG. 3c wherein the lines 401 and 403 are defined above, to (1) cool the mammal 16 (or Mixed Medium) to 34° C. at 2° C./hour during a first time period (area 600), (2) cool the mammal 16 (or Mixed Medium) to 32° C. using a 20° C. maximum differential during a second time period (area 601), (3) during a third time frame, the mammal's (or Mixed Medium's) temperature is to be maintained at 32° C.—to maintain this temperature for the mammal the Mixed Medium is at a maximum pre-set differential, i.e., a 10° C. maximum differential from the mammal's temperature—for 1 hour (area 602); and (4) raise the mammals' (or Mixed Medium's) temperature to 37° C., or any other predetermined temperature at a rate of 4° C. per hour (area 603). Obviously, these examples can be used with different temperatures, different differentials, and different, desired rates. By controlling these rates, temperatures, and differentials individually and/or collectively, by manual means of inputting the data into the processing unit 90, automatic means of a pre-programmed rate and/or temperature, or a combination of both means, the processing unit 90 controls the solenoid valves 32, 34, 320 and manifold 44 to distribute the Mixed Medium at the predetermined temperature and/or predetermined rate.

### Monitor Control

The infrared emitting circuit 800 transmits an infrared signal corresponding to the First Measurement and/or Second Measurement to the infrared receiver circuit and signal converter 802. The First Measurement can be the patient's body core temperature, tympanic temperature, rectal temperature, body surface temperature, oral temperature, and/or any conventional body temperature measurement. Preferably the First Measurement is of the body core temperature which can be measured in some instances by rectal temperature or other invasive measurement means. The signal converter 802 receives the infrared signal and converts that infrared signal to a digital and/or analog signal. The digital and/or analog signal is then transmitted through the signal conduit 804. The distal end of the signal conduit 804 is interconnected to the operating monitor 806, and possibly other various recording and/or data storage devices, including and not limited to a CPU, a printer, and a recordable CD, DVD or equivalent thereof.

As illustrated in FIGS. 1 and 4, the infrared emitting circuit 800 and the infrared receiver circuit and signal converter 802 are adjacent to each other.

While in FIG. 2, the infrared emitting circuit 800 and the infrared receiver circuit and signal converter 802 are a predetermined distance (d) from each other. The predetermined distance (d) is not adjacent to each other as illustrated in FIG. 1 and 4, but it is a distance in which the infrared signal 401 can be transmitted and properly received by the receiver 802. The FIG. 2 embodiment in relation to the predetermined distance (d) between the infrared emitting circuit 800 and the infrared receiver circuit and signal converter 802 decreases the number of wires that are around the operating table since the fluid medium delivery device 10 must be positioned adjacent and/or near the patient to ensure the fluid is delivered to the Object at the desired temperature. When the FIG. 2 infrared embodiment is used, the infrared signal is at a frequency that does not interfere with any of the other instruments used in the operating room and/or patient room.

While preferred embodiments of the present invention have been disclosed, it will be appreciated that it is not limited thereto but may be otherwise embodied with the scope of the following claims.

We claim the following:

1. A device for delivering a desired medium at certain temperature ranges for temperature management of a mammal, comprising:
an inlet source receives the desired medium and directs the desired medium to a temperature-control device;
a bio-feedback device measures the mammal's actual temperature, and transmits the measurement to the temperature-control device and an infrared emitting circuit;
depending on the measurement, the temperature-control device alters the temperature of the desired medium; and
an outlet source directs the desired medium to manage the temperature of the mammal;
the infrared emitting circuit transmits an infrared signal corresponding to the measurement to an infrared receiver circuit and signal converter;
the infrared receiver circuit and signal converter transmits the measurement, in analog or digital format, to a monitor to display and/or record the measurement so medical practitioners can monitor the measurement without looking at the device for delivering a desired medium at certain temperature;
wherein the mammal is to have its temperature set to a predetermined-desired temperature which is entered into the temperature-control device;
wherein when the actual temperature is above the predetermined-desired temperature, the temperature-control device alters the temperature of the desired medium to a predetermined differential from the actual temperature; and
wherein when the actual temperature is below the predetermined-desired temperature, the temperature-control device alters the temperature of the desired medium to a pre-set differential from the actual temperature.

2. The device of claim 1 wherein the desired medium is water.

3. The device of claim 1 wherein the desired medium is air.

4. The device of claim 1 wherein the predetermined differential ranges from 0.1 to 35 degrees Celsius below the actual temperature.

5. The device of claim 1 wherein the predetermined differential ranges from 5 to 15 degrees Celsius below the actual temperature.

6. The device of claim 1 wherein the pre-set differential ranges from 0.1 to 35 degrees Celsius above the actual temperature, so long as the temperature-control device does not alter the temperature of the desired medium above a predetermined-maximum temperature.

7. The device of claim 6 wherein the predetermined-maximum temperature is 0.1 to 10 degrees Celsius above a predetermined-healthy temperature of the mammal.

8. The device of claim 6 wherein the predetermined-maximum temperature is about 5 degrees Celsius above a predetermined-healthy temperature of the mammal.

9. The device of claim 1 wherein the pre-set differential ranges from 5 to 15 degrees Celsius above the actual temperature.

10. The device of claim 1 wherein the temperature-control device is a heat transfer unit with a temperature-measurement instrument.

11. The device of claim 1 wherein the outlet source directs the desired medium into a blanket.

12. The device of claim 11 wherein the blanket has a plurality of channels.

13. The device of claim 11 wherein the blanket has a plurality of apertures directing the desired medium in the direction of the mammal.

14. The device of claim 1 wherein the outlet source directs the desired medium under a blanket.

15. The device of claim 1 wherein the outlet source directs the desired medium to a mattress.

16. The device of claim 1 wherein the outlet source directs the desired medium to a mattress pad.

17. The device of claim 1 wherein the temperature-control device can alter the temperature of the desired medium at a predetermined rate.

18. The device of claim 1 wherein the predetermined-desired temperature is selected from the group consisting of a temperature below the mammal's normal temperature, the mammal's normal temperature, and a temperature above the mammal's normal temperature.

19. The device of claim 1 wherein the infrared emitting circuit transmits and the infrared receiver circuit and signal converter are adjacent to each other.

20. The device of claim 1 wherein the infrared emitting circuit transmits and the infrared receiver circuit and signal converter are a predetermined distance from each other and that predetermined distance is not adjacent to each other and not beyond the transmission distance of the infrared signal.
